(19) United States
(12) Patent Application Publication
(10) Pub. No.: US 2025/0175672 A1
(43) Pub. Date: May 29, 2025

(54) Delivery of Video Content

(71) Applicant: Comcast Cable Communications, LLC, Philadelphia, PA (US)

(72) Inventor: Yiu Leung Lee, Philadelphia, PA (US)

(21) Appl. No.: 18/520,644

(22) Filed: Nov. 28, 2023

(51) Int. Cl. H04N 21/4402; H04N 21/2662

(52) U.S. Cl. CPC H04N 21/440245; H04N 21/2662

(57) ABSTRACT

Systems, apparatuses, and methods are described for dynamically assigning a plurality of spatial regions of a video frame, to a plurality of communication networks based on the current conditions of the networks, and for simultaneously sending the assigned spatial regions, or subregions, via the plurality of communication networks for reassembly at a rendering device. The video frame may be adaptively sent in response to the changing network conditions, efficiently utilizing all the available bandwidth resources of the communication networks.

### BACKGROUND

When sending video via a communication network, network delays may result in unwanted pauses in presentation of the video, and may hamper a user's viewing experience.

### SUMMARY

The following summary presents a simplified summary of certain features. The summary is not an extensive overview and is not intended to identify key or critical elements.

Systems, apparatuses, and methods are described for sending video content, to a requesting device, simultaneously via a plurality of communication networks. Portions (e.g., portions of frames, groups of pictures, etc.) of the video content may be divided into a plurality of spatial regions of video frames based on types of content in various spatial regions of the frames. Then, based on network connections that are available to the requesting device, portions corresponding to the spatial regions of the video frames may be sent via those network connections. The plurality of spatial regions may be based on current conditions of the network connections. A frame template may be sent to the requesting device, informing it as to which network connections are being used to send the spatial regions, and how the spatial regions should be reassembled to create the video content. Different spatial regions may be sent via different network connections, and spatial region divisions may be changed over time based on changing network conditions.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example block diagram of a video system comprising a video server communicatively coupled to a requesting device via a plurality of communication networks.

FIG. 4 shows an example of a network system comprising a plurality of communication networks.

FIG. 5 shows examples of video frames divided into different plurality of spatial regions.

FIGS. 6A-6B collectively show a flow chart of an example method for using a video server.

FIG. 7 shows a flow chart of an example method from the perspective of a requesting device.

### DETAILED DESCRIPTION

The accompanying drawings show examples of the disclosure. It is to be understood that the examples shown in the drawings and/or discussed herein are non-exclusive and that there are other examples of how the disclosure may be practiced.

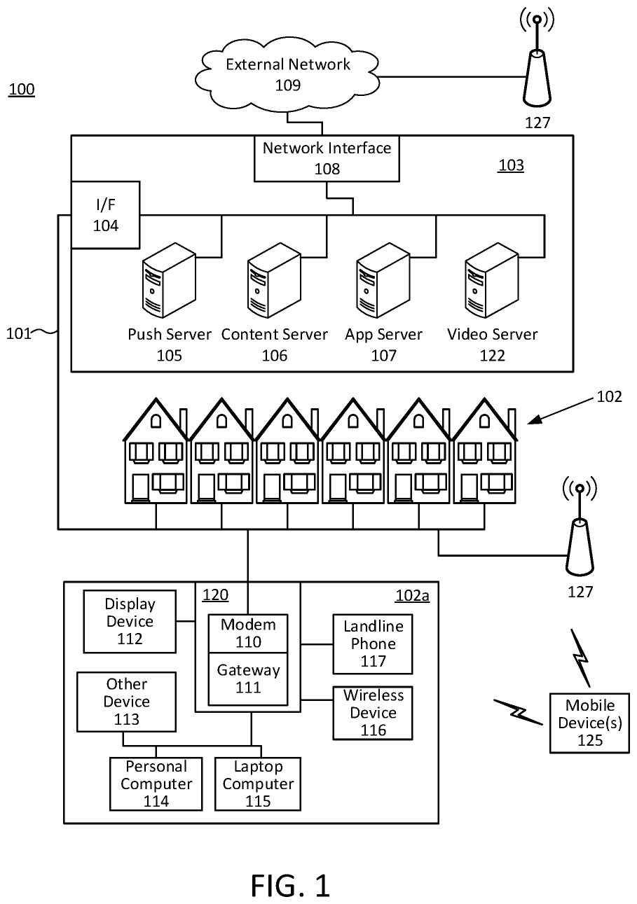

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the video server 122 (described below), additional push, content, and/or application servers, and/or other types of servers. Although shown separately, the push server 105, the content server 106, the application server 107, the video server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

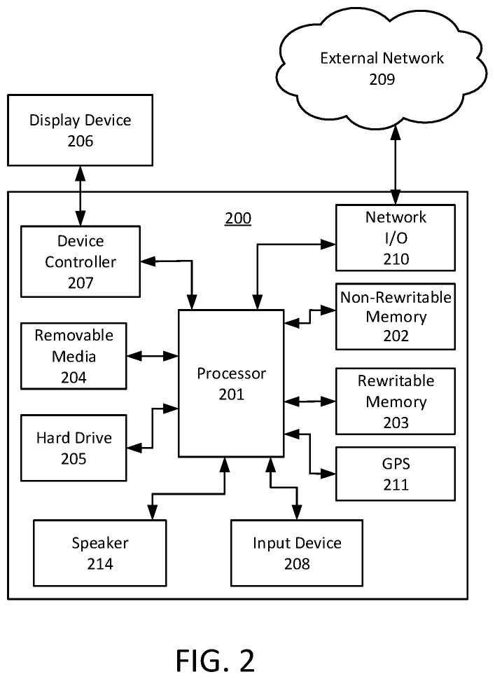

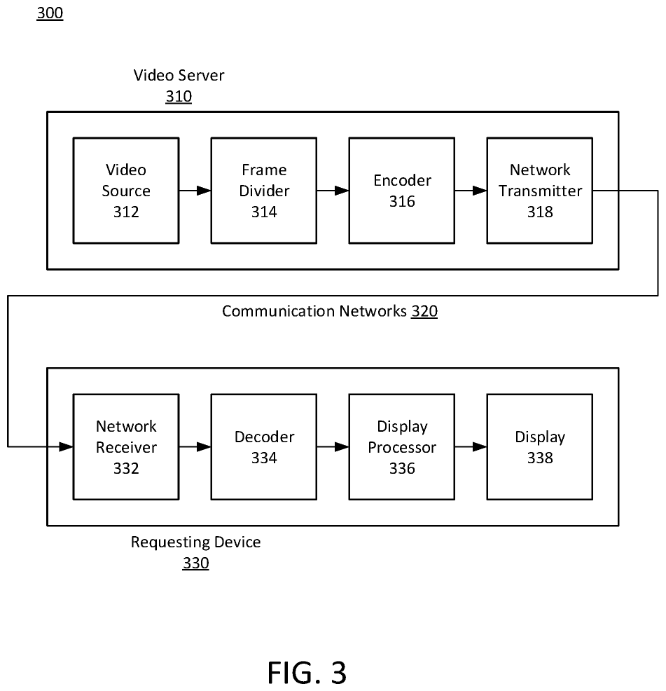

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., a user device such as requesting device 330 as shown in FIG. 3). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

FIG. 3 shows an example block diagram of a video system 300 comprising a video server 310, a plurality of communication networks 320, and/or a requesting device 330. The video server 310 may be communicatively coupled to the requesting device 330 via the plurality of communication networks 320. The requesting device 330 may request a video content item from the video server 310, and may provide the video server 310 with information indicating current network connections (e.g., via communication networks 320) that are available to the requesting device 330. The video server 310 may be configured to divide the video content item into a plurality of spatial regions based on those network connections, and to send the spatial regions via the various communication networks 320. The video server 310 may be the same as and/or substantially similar to the video server 122 shown in FIG. 1. The requesting device 330 may be the same as and/or substantially similar to the devices in the premises 102 and/or to the mobile devices 125 shown in FIG. 1. The plurality of communication networks 320 may be the same as and/or substantially similar to the communication links 101 shown in FIG. 1 and/or to the one or more wireless networks coupled to one or more wireless access points 127 shown in FIG. 1.

The video server 310 may comprise a video source 312, a frame divider 314, an encoder 316, a network transmitter 318, and/or any other module. These elements may simply be functions performed by one or more processors of the video server 310, following execution of instructions such as a computer program stored by the video server 310, and need not be separate elements. The frame divider 314 may be configured to divide a video portion (e.g., a video frame, a group of frames in a group of pictures, etc.), obtained from the video source 312, into a plurality of spatial regions based on the network connections that are available to the requesting device 330. The dividing may be based on the quantity of connections, a complexity of connections, and/or their connection quality, for optimized delivery to the requesting device 330. The encoder 316 may be configured to encode the plurality of spatial regions to generate encoded data streams for sending via different network connections. The network transmitter 318 may be configured to dynamically allocate the encoded data streams of the spatial regions to the plurality of communication networks 320, based on the current conditions of the communication networks 320, and to send the encoded data streams to the requesting device 330 via the plurality of communication networks 320. The video server 310 may also send a frame template, comprising information instructing the requesting device 330 how to obtain and reassemble the spatial regions (e.g., which network connections will carry which spatial regions, the orientation and placement of the spatial regions, etc.).

The requesting device 330 may comprise a network receiver 332, a decoder 334, a display processor 336, a display 338, and/or any other module. The decoder 334 may be configured to decode the encoded data streams (e.g., received simultaneously by the network receiver 332) into the spatial regions. The display processor 336 may be configured to reassemble the spatial regions to create the video frame to be played by the display 338. The reassembly may be based on receiving the frame template discussed above.

The video source 312 may be configured to generate a video content item for consumption by the requesting device 330. The video source 312 may generate video frames at frame sizes, frame rates and/or video formats appropriate for the requesting device 330. For example, the video may be captured by a variety of devices, such as digital recording devices, smartphones, digital cameras, web cameras, and/or any other video capture devices. For example, the video source 312 may receive and/or process video data stored in a content server (e.g., the content server 106 as shown in FIG. 1). For example, the video source 312 may provide video services, such as digital broadcast services, digital televisions, game consoles, and/or any other video services. The generated video frame may be sent to the frame divider 314.

The frame divider 314 may be configured to divide the video frame (e.g., received from the video source 312) into a plurality of the spatial regions (e.g. partial images) for parallel sending, via the plurality of communication networks 320, to the requesting device 330 for playback. The division may determine the spatial regions based on currently measured, or expected, network connections available to the requesting device 330. For example, if it is known (or expected) that the requesting device 330 may have two network connections available (e.g., one having higher bandwidth than the other), then the video frame may be divided into two spatial regions (e.g., one that uses more bandwidth than the other). For example, the video frame may be divided such that an area with large amounts of motion (e.g., result in a larger data file if encoded using a motion-based compression) is designated as a first spatial region (e.g., for sending via the higher-bandwidth network), while a remaining area is a second spatial region (e.g., for sending via the lower-bandwidth network).

A given video frame may be divided into spatial regions in multiple different ways, to accommodate different network situations. For example, a video frame may be divided into three spatial regions, four spatial regions, and/or any other quantity of spatial regions, to accommodate the requesting device 330 that may have three, four, and/or any other quantity of available network connections, respectively. The division may also accommodate known, or expected, qualities of the network connections. For example, a video frame may be divided into three spatial regions in several ways. A first three-way division may assume that the requesting device 330 has two strong network connections (with bandwidth above a threshold) and one weak connection (with bandwidth below another, and/or the same threshold), and this may divide the frame into 2 larger spatial regions and one smaller region. A second three-way division may assume that the requesting device 330 has three equally-strong connections, and that second division may result in three similarly-sized spatial regions, or three spatial regions of approximately the same data size.

A given video frame may be divided many different ways, depending on any combination of known (or expected) network connections. The video frame may be divided in the vertical direction and/or in the horizontal direction. The spatial regions may be obtained by dividing the video frame in an equal manner or may be obtained by dividing the video frame in an unequal manner. For example, the size and/or shape of the spatial regions may be the same as or different from one another. A video frame or video frames of the content item may be divided into different combinations of spatial regions. The spatial regions may have quadrilateral boundaries, and/or they may have irregular boundaries depending on the particular requirements of the video. The frame divider 314 may be configured to divide the video frame on the basis of a layout, a content, and/or a scene of the video frame. Motion-based video compression techniques may require more bandwidth for sending (e.g., transmitting, streaming, etc.) video that comprises more motion, while video with less motion requires less bandwidth, and different networks may be used to send different amounts of data. One spatial region may comprise an area of the video frame with relatively fast and/or large motion, while another spatial region may comprise an area of the video frame with relatively slow and/or small motion. One spatial region may comprise an area of the video frame with text content, while another spatial region may comprise an area of the video frame with image content, as text and images may be compressed differently and may require different amounts of bandwidth to be sent.

Networks may also be chosen for reliability, and more reliable networks may be used to send more important areas of the frame. One spatial region may comprise an area of the video frame that is relatively central, while another spatial region may comprise an area of the video frame that is relatively peripheral, and these may be sent via different networks having different degrees of reliability (e.g., the central portion may be sent via a more reliable network). The frame divider 314 may be configured to generate segment information of the spatial regions divided from the video frame. For example, the segment information may comprise position and/or size information of the spatial regions in the video frame.

The encoder 316 may be configured to generate encoded data streams for the plurality of spatial regions. The encoder 316 may encode the plurality of spatial regions with respect to a resolution of the image, a quality of the compression, a frame rate, and/or any other aspect. The encoder 316 may be configured to encode the plurality of spatial regions based on the conditions of the plurality of communication networks 320. The encoder 316 may adaptively control methods and/or parameters of the encoding process for the spatial regions based on the current connectivity conditions of the communication networks 320. For example, the encoder 316 may compress a spatial region into a relatively low quality image and/or generate a relatively small size of encoded data stream for sending via a relatively low bandwidth communication network. Alternatively, the encoder 316 may compress a spatial region into a relatively high quality image and/or generate a relatively large size of encoded data stream for sending via a relatively high bandwidth communication network. The encoder 316 may comprise a plurality of encoding units to encode the plurality of spatial regions. The plurality of spatial regions may be simultaneously encoded by the plurality of encoding units comprised in the encoder 316. The encoder 316 may operate in accordance with video coding standards, such as International Telecommunications Union Telecommunication Standardization Sector (ITU-T) H.263, ITU-T H.264 and Moving Picture Expert Group (MPEG)-4 Visual (e.g., Advanced Video Coding (AVC)), ITU-T H.265 and MPEG-H Part 2 (e.g., High Efficiency Video Coding (HEVC)), ITU-T H.265 and MPEG-I Part 3 (e.g., Versatile Video Coding (VVC)), the WebM VP8 and VP9 codecs, AOMedia Video 1 (AV1), and/or any other video coding protocol.

The network transmitter 318 may be configured to send the encoded data streams, for the plurality of spatial regions, via the plurality of communication networks 320. The network transmitter 318, for example, may be configured to send the encoded data streams via the plurality of communication networks 320 based on the current conditions of the communication networks 320. The network transmitter 318 may determine which networks are available for sending among the plurality of communication networks 320. The available networks may be used to simultaneously send the plurality of encoded data streams to the requesting device 330. The network transmitter 118 may also send a frame template, containing instructions regarding how to receive the different spatial regions (e.g., which network connections will carry which spatial regions), and how the spatial regions should be reassembled (e.g., their spatial and/or temporal relationship). The network transmitter 318 may determine current network connectivity conditions with respect to the plurality of communication networks 320, such as bandwidth, latency, error rate, and/or any other network conditions. The network transmitter 318 may receive current connectivity conditions regarding the plurality of communication networks 320 from the requesting device 330, and/or may use information from the requesting device 330 to determine the current connectivity conditions regarding the plurality of communication networks 320.

The communication networks 320 may be configured to simultaneously deliver the encoded data streams for the plurality of spatial regions and/or the frame template, from the network transmitter 318 to the network receiver 332. The communication networks 320 may comprise one or more wireless networks (e.g., cellular networks, satellite networks, Wi-Fi networks, etc.), one or more wired networks (e.g., fiber-optic networks, ethernet networks, etc.), and/or any combination of wireless and wired networks, wherein two or more of the communication networks 320 are maintained in communication for the simultaneous sending of the encoded data streams. The different networks of the communication networks 320 may comprise different network connectivity conditions, such as bandwidth, latency, error rate, and/or any other network conditions. The network transmitter 318 and/or the network receiver 332 may be configured to support communication protocols suitable for the communication networks 320. The communication networks 320 may comprise communication network devices such as modems, routers, switches, gateways, access points, antennas, satellite dishes, towers, optical-electrical interfaces, and/or any other network devices.

The network receiver 332 may be configured to simultaneously receive the encoded data streams for the spatial regions of the video frame, and/or the frame template, from the video server 310 via the plurality of communication networks 320. The network receiver 332 may be configured to send current connectivity conditions related to the plurality of communication networks 320, such as quantity of active connections, complexity of active connections, bandwidth, latency, error rate, and/or any other network conditions, to the video server 310. The network receiver 332 may be configured to provide information to the video server 310 to determine the current connectivity conditions with respect to the plurality of communication networks 320, such as bandwidth, latency, error rate, and/or any other network conditions using the information.

The decoder 334 may be configured to decode the encoded data streams, received by the network receiver 332, and to reproduce the spatial regions of the video frame. For example, the decoder 334 may comprise a plurality of decoding units to decode the plurality of encoded data streams. The plurality of encoded data streams may be simultaneously decoded by the plurality of decoding units comprised in the decoder 334 for the spatial regions. The plurality of encoded data streams for the spatial regions may be independently decoded from each other by the decoder 334. The decoder 334 may operate in accordance with video coding standards (e.g., used for encoding).

The display processor 336 may be configured to assemble the spatial regions into the video frame to be displayed by the display 338. This may be done using the frame template, which as noted above, may comprise information regarding receipt and reassembly of the spatial regions. The frame template may include segment information, such as a position and/or a size of the spatial regions and/or timing information such as a video frame number. The segment information of the spatial regions may be used to assemble the spatial regions into the video frame (or multiple frames) by the display processor 336. The display 338 may play the video frame reconstructed by the display processor 336. Further, a plurality of different frame templates that correspond to a plurality of different network conditions and that divide a video frame in a plurality of different ways may be determined.

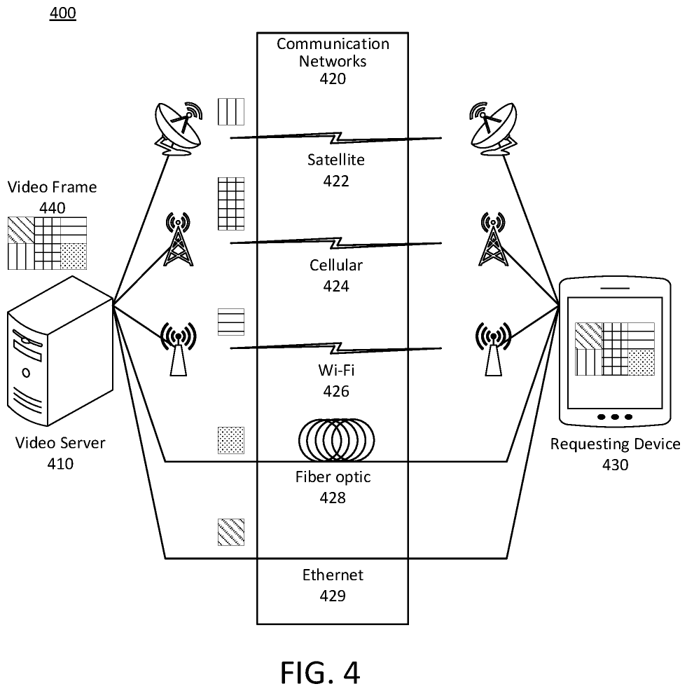

FIG. 4 shows an example of a network system 400 comprising a plurality of communication networks 420. The communication networks 420 may communicationally couple a video server 410 to a requesting device 430. The communication networks 420 may comprise a satellite network 422, cellular network 424 (e.g., LTE network, 5G network, etc.), a Wi-Fi network 426, a fiber-optic network 428, an ethernet network 429, and/or any other communication network. The communication networks 420 may be configured to support simultaneous sending of a plurality of spatial regions (e.g., divided from a video frame 440), from the video server 410 to the requesting device 430. The video server 410 may be configured to determine current connectivity conditions for the communication networks 420, comprising bandwidth, latency, error rate, and/or any other network conditions. The video server 410 may receive the current connectivity conditions with respect to the communication networks 420 from the requesting device 430, and/or may use information from the requesting device 430 to determine the current connectivity conditions with respect to the communication networks 420.

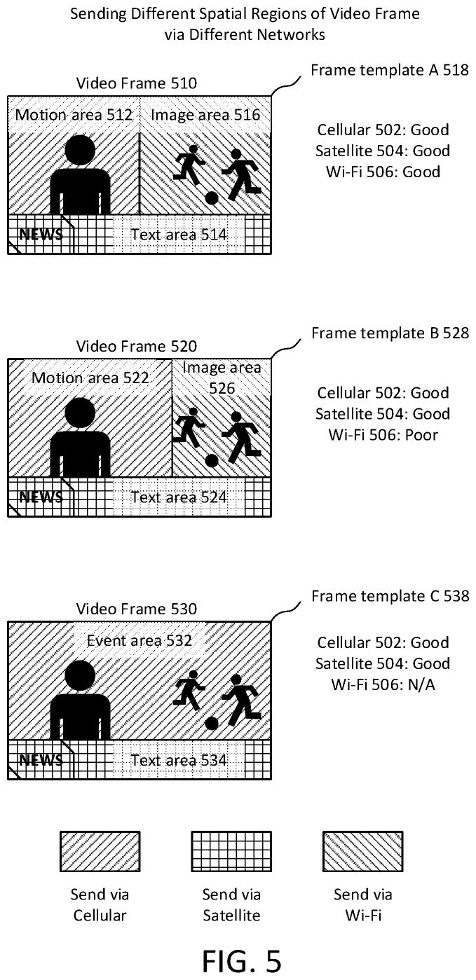

FIG. 5 shows multiple examples of how a video frame may be divided into different pluralities of spatial regions based on available network conditions. The spatial regions may be configured to be sent via a plurality of communication networks (e.g., a cellular network 502, a satellite network 504, and a Wi-Fi network 506). The video frames 510, 520, and 530 may be divided into the spatial regions based on network connections that are (or are expected to be) available to a requesting device (e.g., the requesting device 330/430). The definition of the spatial regions may be stored in a frame template, which may comprise boundary information (e.g., a position, a size, etc.) of the different spatial regions. A template may be generated based on the quantity of the available (or the expected) network connection, a complexity of the available (or expected) networks, and/or their connection quality, for optimized delivery to the requesting device 330/430. The video frames 510, 520, and 530 may be divided into the spatial regions based on a frame template A 518, a frame template B 528, and a frame template C 538, respectively. For example, three communication networks (e.g., the cellular network 502, the satellite network 504, and the Wi-Fi network 506) may be determined in good condition for sending the video frame 510. The video frame 510 may be divided into three spatial regions based on the three available network connections. A different quantity of spatial regions may be defined, for the same video frame 510, to accommodate different possible combinations of available networks.

Different spatial regions of a video frame may be sent via different communication networks, which may comprise different and diverse network conditions (e.g., bandwidth, latency, etc.). The spatial regions may be prioritized based on complexity and bandwidth needed for the spatial regions, for sending the spatial regions via the different communication networks. For example, a motion area 512 (e.g., a news presenter presents) may comprise a more complex, higher degree of motion than a text area 514 (e.g., a text news presents) and an image area 516 (e.g., a still image news presents). The motion area 512 (e.g., with a higher degree of motion) may require more bandwidth for sending than spatial regions comprising less amount of data (e.g., the text area 514 and the image area 516). The text area 514 and the image area 516 may be compressed differently using different encoding algorithms. The image area 516 may require more amount of bandwidth to be sent than the text area 514. The spatial regions may be assigned to networks based on the data size of the regions and the bandwidth of the networks. The motion area 512 (e.g., comprising a first priority) may be sent via a high bandwidth network (e.g., the cellular network 502). While the image area 516 (e.g., comprising a second priority) may be sent via a medium bandwidth network (e.g., the Wi-Fi network 506), and the text area 514 (e.g., comprising a third priority) may be sent via a low bandwidth network (e.g., the satellite network 504), at the time for sending the video frame 510.

The image size of the spatial regions may be determined based on the connectivity conditions of the communication networks, and the connectivity conditions of the communication networks may change over time. Accordingly, the different divisions shown in the video frames 510-530 may be used at different times, and while the example shows the same contents in the video frames 510-530, the differences in spatial regions may be applied to different frames as needed. The frame template B 528 may be determined to accommodate the change in connectivity conditions of the Wi-Fi network 506, such that the image size of an image area 526 is reduced from the image size of the image area 516 based on the reduced bandwidth of the Wi-Fi network 506. The cellular network 502 bandwidth may be sufficient to support a motion area 522 that is expanded from the motion area 512 (e.g., as the image area 526 is reduced from the image area 516), while a text area 524 is the same as the text area 514. The Wi-Fi network 506 may be not available at the time of sending the video frame 530. The frame template C 538 may be determined based on the two available communication networks (e.g., the cellular network 502 and the satellite network 504) for sending the video frame 530. The video frame 530 may be divided into two spatial regions (e.g., an event area 532 and a text area 534) based on the two available network connections.

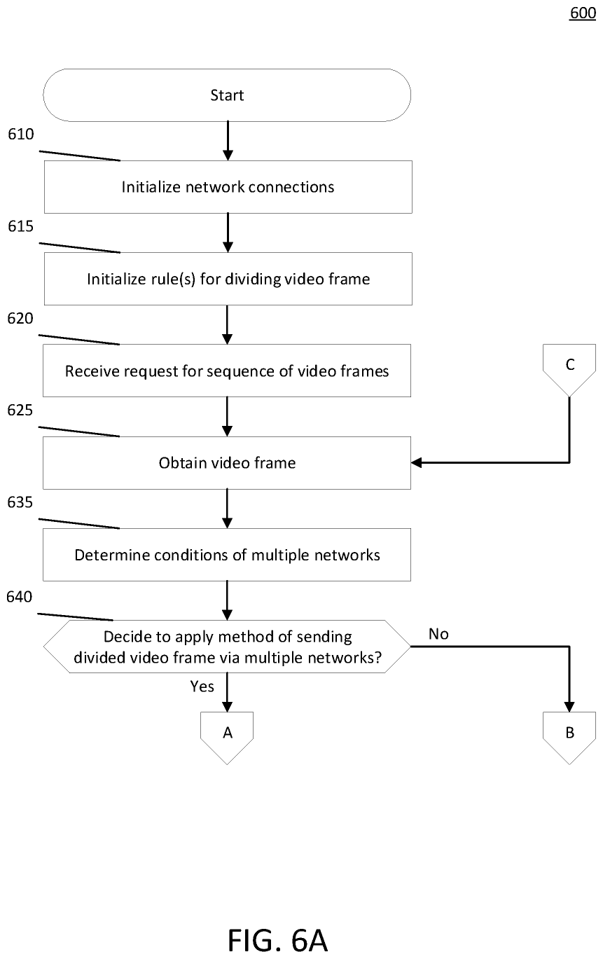

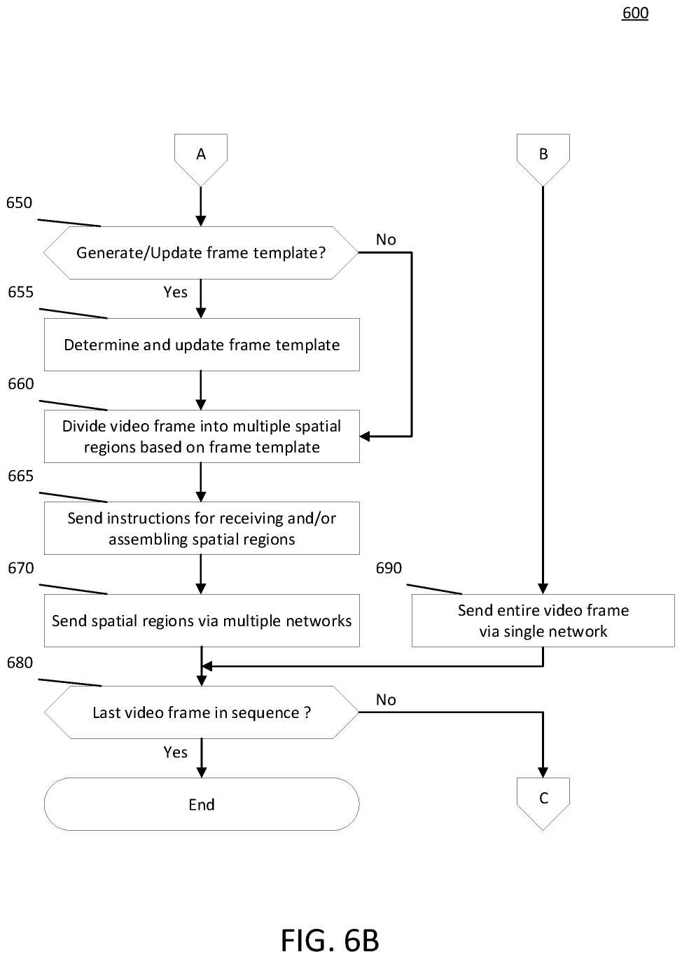

FIGS. 6A-6B collectively shows a flow chart 600 of an example method for using a video server (e.g., the video server 310/410). In step 610, network connections of the video server 310/410 may be initialized. The initializing network connections may establish network connections between the video server 310/410 and the requesting device 330/430. The network connections may be established to simultaneously send a plurality of spatial regions of a video frame from the video server 310/410 to the requesting device 330/430. Examples of how these connections may be established may comprise receiving a signal from a cellular tower and requesting a connection to the tower to establish the cellular network 502, sending a beacon via a satellite dish to establish the connections using the satellite network 504, and/or receiving a message from a Wi-Fi router and sending a response to register with the router for the Wi-Fi network 506. The network connections may be established by obtaining separate internet protocol (IP) connections for each of them from their respective internet service providers (ISPs).

The initializing network connections may set (or limit) the maximum capacity (e.g., bandwidth) of communication networks (e.g., the communication networks 320/420) that may be used to send spatial regions of a video frame. For example, the established network connections (e.g., via the cellular network 502, the satellite network 504, and/or the Wi-Fi network 506) may be limited to a maximum transmission rate (e.g., of 100 Mbps, 40 Mbps, and 60 Mbps, respectively). The communication networks 320/420 may be used (or expected to be used) for other tasks at the same time as they are used to send spatial regions of a video frame. The maximum capacity (e.g., bandwidth) of the communication networks 320/420 may be set (or limited) to conserve the capacity (e.g., bandwidth) of the communication networks 320/420 for the other tasks. For example, the requesting device 330/340 may receive one or more push notifications from a push server (e.g., the push server 105) and/or download one or more applications (or information of applications) from an application server (e.g., the application server 107) via the communication networks 320/420, while the communication networks 320/420 are used to send spatial regions of a video frame. The bandwidth of the communication networks 320/420 may be conserved for optimized delivery of push notifications and/or applications to the requesting device 330/340, by setting (or limiting) the maximum bandwidth of the communication networks 320/420 for sending the spatial regions. Alternatively, the initializing network connections may reserve bandwidth for other tasks while using it to send spatial regions of a video frame. For example, the network connections (e.g., the cellular connection of cellular network 502, the satellite connection of the satellite network 504, and the Wi-Fi connection of the Wi-Fi network 506) may be configured to reserve a 10 Mbps transmission rate for other tasks while being used to send spatial regions of a video frame.

The initializing network connections may set (or limit) the minimum capacity (e.g., bandwidth) of each communication network that may be involved in sending the spatial regions. The minimum capacity may be used to determine communication networks to be used for sending the spatial regions. For example, a minimum threshold of 15 Mbps may be established for downstream bandwidth, and if a network does not have at least 15 Mbps of downstream bandwidth available for delivering spatial regions, then the network may be deemed unavailable for delivering spatial regions. As shown in FIG. 5, the Wi-Fi network 506 may be determined to be unavailable for sending the spatial regions of the video frame 530, due to the connectivity conditions of the Wi-Fi network (e.g., 9 Mbps of bandwidth, which is less than the minimum threshold of 15 Mbps), at the time of sending the video frame 530. The minimum bandwidth of network connections may be determined based on a quantity of spatial regions to be sent via the communication networks 320/420. The minimum bandwidth may be determined by dividing the bandwidth, required to send the entire video frame, by the quantity of the spatial regions. For example, the minimum bandwidth of 15 Mbps may be determined for the video frame 530 (e.g., estimated that 30 Mbps transmission rate is required to send without dividing) based on the two spatial regions (e.g., the event area 532 and the text area 534).

In step 615, rule(s) for dividing a video frame may be initialized. The rule(s) may comprise instructions for determining a frame template, which may be used to divide the video frame into a plurality of spatial regions. The initializing rule(s) may establish a quantity (e.g., a number) of the spatial regions based on the current connectivity conditions of the communication networks. The rule(s) may be established to indicate that a frame template divides a video frame into the same quantity of spatial regions as the communication networks available for sending the spatial regions. For example, each of the spatial regions may correspond to an associated network of the communication networks (e.g., a plurality of networks that may comprise communication networks that are available for sending the spatial regions). The initializing rule(s) may establish spatial regions to capture different types of content in a video frame. The spatial regions may comprise areas of motion content, text content, image content, and/or any other content. As shown in FIG. 5, the frame template A 518 may be used to divide the video frame 510 into three spatial regions (e.g., the motion area 512, the text area 514, and the image area 516), which correspond to the three communication networks available for sending the video frame 510. The motion area 512 may comprise the region where a news presenter appears in the video frame 510. The text area 514 may comprise the portion of the video frame 510 where text news is presented, while the image area 516 may comprise the space where a still image news is presented.

The initializing rule(s) may establish the image sizes of the spatial regions based on the current connectivity conditions of the communication networks. The rule(s) may be established to indicate that the frame template comprises the image sizes of the spatial regions based on the quality (e.g., bandwidth, latency, error rate, etc.) of the communication networks. As shown in FIG. 5, the frame template B 528 may comprise the image size of the image area 526 based on the changes in the Wi-Fi network 506 connectivity. The image size of the image area 526 may be reduced from the image size of the image area 516 to accommodate the reduced bandwidth of the Wi-Fi network 506 at the time the video frame 520 is sent. For example, each of the communication networks (e.g., the cellular network 502, the satellite network 504, and/or the Wi-Fi network 506) may comprise a bandwidth more than the estimated bandwidth of 30 Mbps (e.g., required to send the entire video frame 510) at the time of sending the video frame 510. The frame template A 518 may be determined to divide the video frame 510, such that the motion area 512 and the image area 516 comprise the same image size of 1920×1620, and the image size of the text area 514 is 3840×540. The frame template B 528 may be determined to reduce the image size of the image area 526 to 1440×1620, based on 20 Mbps of the Wi-Fi network 506 bandwidth (e.g., less than the 30 Mbps bandwidth required to send the entire video frame 520) at the time of sending the video frame 520. The initializing rule(s) may establish frame rates and/or video formats of spatial regions. The rule(s) may be established such that the frame template indicates different frame rates and/or video formats for different spatial regions. For example, the frame template A 518 may indicate that the motion area 512 (e.g., of a high degree of motion) and the image area 516 (e.g., of image content) are encoded using the H.265 codec at 30 frames-per-second (FPS), while the text area 514 (e.g., of text content) is encoded using the H.264 codec at 24 FPS. The rule(s) may be established such that the first spatial region comprises a larger image size than the second spatial region and/or the first network comprises more capacity than the second network.

The initializing rule(s) may establish a frame template update frequency. The rule(s) may be established to indicate how often a frame template should be updated. Updating a frame template may increase the processing time of dividing a video frame into a plurality of spatial regions. Updating a frame template on a frame-by-frame basis may unnecessarily slow down the processing time, if the connectivity conditions of communication networks are stable enough to use the same frame template that was updated (or determined) for a previous video frame. A frame template may be updated on a group-of-pictures (GOP) basis (e.g., to reduce the processing time). For example, all subsequent video frames in a GOP may adopt the same frame template, once the frame template is determined for a key frame in the GOP. The update frequency may indicate that a frame template should be updated once per minute, or any other duration. The rule(s) may be created in advance and/or offline. Multiple rule sets may be created to anticipate multiple combinations of available networks and network qualities.

In step 620, a request for a sequence of video frames may be received. The request may comprise a request to stream a video program comprising a content item at a desired quality (e.g., frame sizes, frame rates, and/or video formats) appropriate for consumption by the requesting device 330/430. The video frames may be video data that is stored on a content server (e.g., the content server 106). In step 625, a video frame of the sequence of video frames may be obtained (e.g., to be sent to the requesting device 330/430) based on the request.

In step 635, the conditions of a plurality of communication networks (e.g., the communication networks 320/420) may be determined. The connectivity conditions for the plurality of communication networks 320/420 may comprise parameters, such as bandwidth, latency, error rate, and/or any other network conditions. The network connectivity conditions may be reported from the requesting device 330/430, which may periodically measure the connectivity condition of the communication networks 320/420. The network connectivity conditions may be determined based on network information of the communication networks 320/420 provided from the requesting device 33/430. The example method may show a determination of network conditions on a frame-by-frame basis as discussed herein. The method may be revised to determine network conditions less frequently (or more frequently). Different communication networks may comprise different network connectivity conditions. The connectivity conditions of communication networks may change over time. As shown in FIG. 5, the Wi-Fi network 506 may comprise different connectivity conditions at the time of sending different video frames. The connectivity conditions of the Wi-Fi network 506 may be determined to be good, poor, and unavailable at the time of sending the video frames 510, 520, and 530, respectively.

In step 640, a decision may be made as to whether to apply the sending method (e.g., sending a plurality of spatial regions of a video frame via a plurality of communication networks) to the video frame (e.g., obtained in step 625). The decision may made based on the current connectivity conditions of the plurality of communication networks 320/420 (e.g., determined in step 635). For example, the sending method may be inappropriate for the video frame in cases, such as there is only one communication network available to the requesting device 330/430, the available bandwidth of the communication networks 320/420 is less than the minimum bandwidth (e.g., set in step 610), and/or any other cases. If it is determined that the sending method is unsuitable for the video frame (e.g., No in step 640), the entire video frame (e.g., without dividing using a frame template) may be sent via a single network in step 690.

In step 650, a determination may be made whether to generate and/or update a frame template, if it is decided to apply the sending method to the video frame (e.g., Yes in step 640). The determination to generate and/or update the frame template may be made according to the frame template update frequency (e.g., the established rule(s) in step 615). For example, if no frame template has been generated yet, then a frame template for the video frame may be generated using the rules discussed above. Alternatively, if a frame template has already been generated, but the update frequency rule indicates it is time to update the rule, then the frame template may be updated according to the rules. If the determination yields a positive result (e.g., Yes in step 650), the process may proceed to step 655 for generating and/or updating the frame template based on the current connectivity conditions of the communication networks 320/420. While the frame template may remain unchanged from the previous state, if the determination yields a negative result (e.g., No in step 650). For example, the frame template A 518 may be determined for the video frame 510, which is a key frame of a GOP, based on the current connectivity conditions of the communication networks 320/420 at the time the video frame 510 is sent. The frame template A 518 may be used for all subsequent video frames in the GOP, or for any other duration specified in the rule(s) discussed above.

In step 655, the frame template may be generated and/or updated based on the current connectivity conditions of the communication networks 320/420. The frame template may be instructed by the rule(s) (e.g., established in step 615) to divide the video frame into a plurality of spatial regions based on the current connectivity conditions of the communication networks 320/420. The frame template may be generated and/or updated based on the quantity of the available communication networks and/or their connection quality. The frame template may be configured to divide the video frame into the same quantity of spatial regions as the quantity of the available network connections. The frame template may be instructed by the rule(s) to capture different types of content in the video frame into the spatial regions. As shown in FIG. 5, the video frame 530 may be divided into two spatial regions (e.g., the event area 532 and the text area 534), based on the two available communication networks (e.g., the cellular network 502 and the satellite network 504) for sending the video frame 530. The event area 532 may comprise the region where a news presenter and a still image news appear in the video frame 530. While the text area 534 may comprise the portion of the video frame 530 where text news is presented. The frame template may be instructed by the rule(s) (e.g., established in step 615) to determine the image size of the spatial regions based on the quality of the communication networks 320/420. As shown in FIG. 5, the event area 532 comprising a large image size may be sent via a high bandwidth network (e.g., the cellular network 502 of 100 Mbps), while the text area 534 comprising a small image size may be sent via a low bandwidth network (e.g., the satellite network 504 of 40 Mbps). In step 660, the video frame may be divided into a plurality of spatial regions based on the frame template.

In step 665, instructions for receiving and/or assembling the spatial regions may be sent to reconstruct the video frame (e.g., on the requesting device 330/430). A frame template may comprise information about which network connections may be used to send spatial regions and/or information about how to reassemble the spatial regions. For example, the frame template A 518 may indicate that the motion area 512, the text area 514, and the image area 516 may be sent via the cellular network 502, the satellite network 504, and/or the Wi-Fi network 506, respectively. The frame template may comprise segment information. For example, the frame template may comprise position information of the spatial regions in the original video frame before divided. The position information may indicate the top left most pixel (e.g., the x and y coordinates from the top left most pixel of the video frame) of the spatial regions in the video frame, such that the 1×1 indicates the motion area 512, 1×1621 indicates the text area 514, and 1921×1 indicates the image area 516 in the frame template A 518. The frame template may comprise image size information of the spatial regions (e.g., the width and the height of the spatial regions), such that the motion area 512 and the image area 516 comprise the image size of 1920×1620, and the image size of 3840×540 is indicated for the text area 514. The frame template may comprise frame rate (e.g., FPS) and/or video format (e.g., codec) information of the spatial regions. For example, the frame template A 518 may indicate that the H.265 codec at 30 FPS is used for the motion area 512 and the image area 516, while the H.264 codec at 24 FPS is used for the text area 514.

The frame template may comprise size information of the video frame (e.g., the width and the height of the video frame), for example, the video frame 510 may comprise the image size of 3840×2160. In step 670, the plurality of spatial regions may be sent via the plurality of communication networks 320/420. The spatial regions may be sent simultaneously via the communication networks 320/420 allocated to the spatial regions. If the current video frame is the last one in the requested sequence of video frames (Yes in step 680), the process may be terminated. The process may proceed to step 625 to obtain the next video frame in the sequence of video frames, if there are video frames remaining in the sequence (No in step 680). Although the example method of FIG. 6 describes determining a frame template on a frame-by-frame basis, the video server 310/410 may preprocess a video content item in advance with a plurality of possible frame templates for different network connectivity conditions, and then select (or send) a set of spatial regions divided using a frame template corresponding to the current connectivity conditions of the communication networks 320/420.

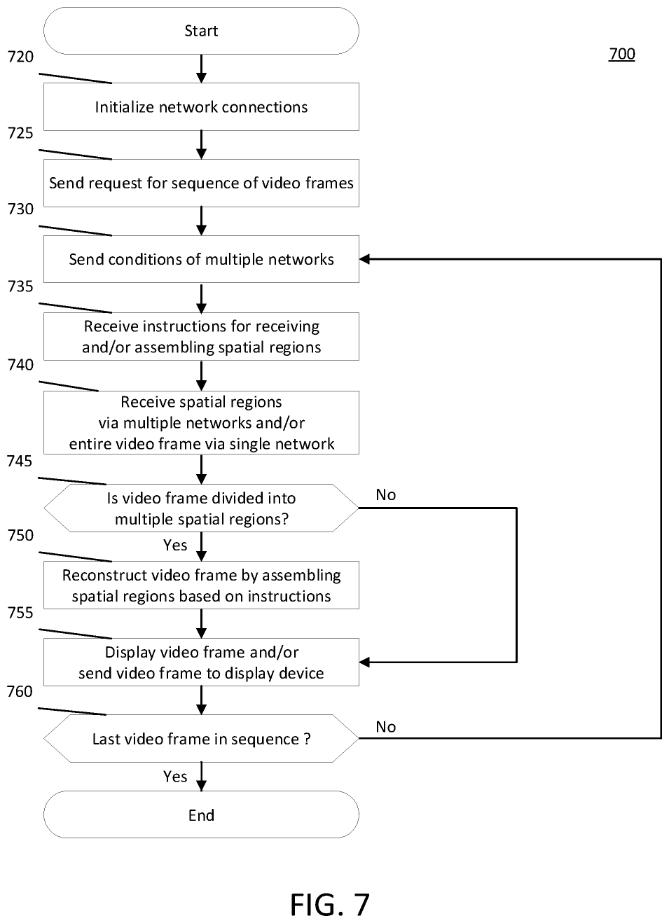

FIG. 7 shows a flow chart 700 of an example method from the perspective of a requesting device (e.g., the requesting device 330/430). In step 720, network connections of the requesting device 330/430 may be initialized. The initializing network connections may establish network connections between the video server 310/410 and the requesting device 330/430, as described with respect to FIG. 6. The initializing network connections may establish a main network connection among the network connections available for receiving spatial regions. The main network connection may be used to receive instructions (e.g., a frame template) that indicate which network connections to be used to receive spatial regions of a video frame and/or how to reassemble the spatial regions to reconstruct the video frame. A network connection with the largest bandwidth (e.g., among the available network connections) may be determined as the main network. For example, the cellular network 502 may be determined as the main network for receiving the frame template A 518, based on the transmission rates of the available network connections (e.g., 100 Mbps bandwidth of the cellular network 502, 40 Mbps bandwidth of the satellite network 504, and 60 Mbps bandwidth of the Wi-Fi network).

In step 725, a request for video content may be sent. For example, a user may browse to a streaming site and request to stream a video from the streaming site. The video may comprise a sequence of the video frames in an appropriate quality (e.g., frame sizes, frame rates and/or video formats) to be used by the requesting device 330/430. The sequence of video frames may comprise a content item. In step 730, the conditions of a plurality of communication networks (e.g., the communication networks 320/420) may be sent (or reported) for use in dividing a video frame (e.g., an indication of connectivity conditions of a plurality of networks (e.g., communication networks) may be sent). For example, network information of the communication networks 320/420 may be sent to be used by for the video server 310/410 to determine the current network conditions.

In step 735, instructions for receiving and/or assembling spatial regions to reconstruct a video frame may be received. For example, a frame template may be received via the main network connection (e.g., established in step 720). The frame template may comprise instructions on the network connections to be used to receive the different spatial regions, and their spatial and/or temporal relationship. In step 740, a plurality of spatial regions may be received. The spatial regions may be received via the different communication networks indicated in the frame template (e.g., received in step 735). Alternatively, an entire video frame (e.g., without dividing) may be received via a single communication network. If an entire video frame (e.g., via a single communication network) is received in step 740 (e.g., No in step 745), then the received video frame may be displayed on the requesting device 330/430 and/or may be sent to the display device 206 in step 755.

If a plurality of spatial regions are received via the plurality of communication networks 320/420 in step 740 (e.g., Yes in step 745), the received spatial regions may be assembled using the frame template (e.g., received in step 735) in step 750. The frame template may be used to reconstruct the video frame by assembling the spatial regions. The frame template may comprise segment information for reassembly, such as position information and/or size information of spatial regions in the original video frame before divided. The video frame may be reproduced based on the frame template. In step 755, the reconstructed video frame (e.g., by assembling the spatial regions) may be displayed afterwards on the requesting device 330/430 and/or may be sent to the display device 206. If the current video frame is the last one in the requested sequence of video frames (Yes in step 760), the process may be terminated. The process may proceed to step 730 for the next video frame in the sequence of video frames, if there are video frames remaining in the sequence (No in step 760).

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device and from a requesting device, a request for a content item comprising a sequence of video frames;
receiving information indicating connectivity conditions of a plurality of networks that are available to the requesting device;
dividing, based on the connectivity conditions, a video frame of the sequence into a plurality of spatial regions;
sending, via a first network of the plurality of networks, a first spatial region of the plurality of spatial regions; and
sending, via a second network of the plurality of networks, a second spatial region of the plurality of spatial regions.

2. The method of claim 1, wherein the dividing comprises determining a quantity of the spatial regions based on a quantity of the plurality of networks.

3. The method of claim 1, wherein the dividing comprises determining one or more image sizes of the plurality of spatial regions based on the connectivity conditions.

4. The method of claim 1, wherein the dividing comprises:
determining a frame template that corresponds to the connectivity conditions; and
splitting, based on the frame template, the video frame into the plurality of spatial regions.

5. The method of claim 1, further comprising determining a plurality of different frame templates that correspond to a plurality of different network conditions and that divide a video frame in a plurality of different ways.

6. The method of claim 1, further comprising dividing different video frames of the content item into different combinations of spatial regions.

7. The method of claim 1, wherein the first spatial region is adjacent to the second spatial region.

8. The method of claim 1, further comprising sending, to the requesting device, instructions for assembling the plurality of spatial regions.

9. The method of claim 1, further comprising:
determining the plurality of spatial regions based on a frame template; and
sending the frame template for assembling the plurality of spatial regions.

10. The method of claim 1, wherein the first spatial region comprises more data than the second spatial region, and the first network comprises more capacity than the second network.

11. The method of claim 1, wherein the first spatial region comprises a higher degree of motion than the second spatial region, and the first network comprises more capacity than the second network.

12. The method of claim 1, wherein the first spatial region comprises a larger image size than the second spatial region, and the first network comprises more capacity than the second network.

13. The method of claim 1, further comprising:
determining, based on the connectivity conditions of the first network, a frame rate of the first spatial region; and
determining, based on the connectivity conditions of the second network, a frame rate of the second spatial region.

14. The method of claim 1, further comprising:
encoding, based on the connectivity conditions of the first network, the first spatial region; and
encoding, based on the connectivity conditions of the second network, the second spatial region.

15. The method of claim 1, further comprising sending, to the requesting device, information indicating that the first network is associated with the first spatial region, and the second network is associated with the second spatial region.

16. The method of claim 1, wherein the dividing comprises determining a quantity of the spatial regions based on a complexity of the plurality of networks.

17. A method comprising:
requesting, from a computing device, a video frame to be divided into a plurality of spatial regions, each of the plurality of spatial regions corresponding to an associated network of a plurality of networks;
receiving the plurality of spatial regions via each associated network of the plurality of networks; and
assembling the plurality of spatial regions to reproduce the video frame.

18. The method of claim 17, wherein the assembling comprises:
receiving, from the computing device, instructions for assembling the spatial regions; and
combining the spatial regions based on the instructions.

19. The method of claim 17, further comprising sending, to the computing device, an indication of connectivity conditions of the plurality of networks.

20. The method of claim 17, wherein the receiving comprises:
receiving, via a first network of the plurality of networks, a first spatial region of the plurality of spatial regions; and
receiving, via a second network of the plurality of networks, a second spatial region of the plurality of spatial regions.

21. The method of claim 17, further comprising receiving, from the computing device, information indicating that a first network of the plurality of networks is associated with a first spatial region of the plurality of spatial regions, and a second network of the plurality of networks is associated with a second spatial region of the plurality of spatial regions.
